(19) United States
(12) Patent Application Publication
(10) Pub. No.: US 2022/0051385 A1
(43) Pub. Date: Feb. 17, 2022

(54) METHOD, DEVICE AND APPARATUS FOR PREDICTING PICTURE-WISE JND THRESHOLD, AND STORAGE MEDIUM

(71) Applicant: SHENZHEN INSTITUTES OF ADVANCED TECHNOLOGY CHINESE ACADEMY OF SCIENCES, Guangdong (CN)

(72) Inventors: Yun ZHANG, Guangdong (CN); Huanhua LIU, Guangdong (CN)

(73) Assignee: SHENZHEN INSTITUTES OF ADVANCED TECHNOLOGY CHINESE ACADEMY OF SCIENCES, Guangdong (CN)

(21) Appl. No.: 17/312,736

(22) PCT Filed: Dec. 12, 2018
(86) PCT No.: PCT/CN2018/120749

§ 371 Date: Jun. 10, 2021

(51) Int. Cl. G06T 7/00; G06K 9/46; G06K 9/62; G06K 9/00; G06T 7/11; G06N 3/04

(52) U.S. Cl. CPC G06T 7/0002; G06K 9/46; G06K 9/629; G06K 9/00979; G06K 9/6257; G06T 2207/20021; G06N 3/0454; G06T 2207/10016; G06T 2207/20081; G06T 2207/20084; G06T 2207/30168; G06T 7/11

(57) ABSTRACT

A prediction method, device, equipment, and storage medium for the image-level JND threshold, comprising: perceptual distortion discrimination is conducted on the raw image and on the compressed images in the compressed image set of the said image through trained multi-class perceptual distortion discriminator to obtain the set of perceptual distortion discrimination results (S101), and preset image-level JND search strategies are adopted for fault tolerance of the said set of perceptual distortion discrimination results to predict the image-level JND threshold of the said image (S102), thus reducing the prediction deviation of the image-level JND threshold, improving the prediction accuracy of the image-level JND threshold, and bringing the predicted JND threshold closer to the human visual system's perception of the quality of the entire image.

### FIELD OF THE INVENTION

The invention relates to the prediction method, device, equipment, and storage medium for the image-level JND threshold, which belongs to the technical field of image/video compression.

### BACKGROUND TECHNOLOGY

It is found from previous studies that the human visual system's perception of visual information is a non-uniform and nonlinear information processing process in which there is certain visual psychology redundancy when observing images with human eyes, thus selectively ignoring or shielding some features or contents in the images. Based on various shielding characteristics of the human visual system, human eyes cannot perceive subtle changes in the image pixels below a certain threshold, namely, imperceptible changes for human eyes. This threshold refers to human eyes' Just Noticeable Distortion (JND) threshold that represents visual redundancy in the image. JND Threshold describes the minimum image distortion perceived by human eyes and reflects the human visual system's perception and sensitivity. Therefore, the JND threshold has been widely used for image/video processing, such as image/video encoding, streaming application, and watermarking technique.

At present, multiple JND models have been proposed, which are generally divided into two categories: pixel domain-based JND models and frequency domain-based JND models. Pixel domain-based JND models mainly take into account the influence of adaptive illumination effect and spatial masking effect on JND threshold. For instance, Wu et al. adopted the regularity of spatial structure to measure spatial masking effect and proposed a new JND model to enhance the accuracy of estimating the JND threshold of irregular texture regions in 2012 in combination with the adaptive illumination effect; Wu et al. believed that the presence of a disordered concealing effect would lead to higher JND threshold of disordered regions than that of effective regions, so they put forward a JND model based on Free Energy Principle in 2013; Meanwhile, by taking advantage of adaptive illumination effect and structured uncertainty, Wu et al. proposed a function of pattern masking effect in 2013 and further put forward a JND model on the basis of pattern masking effect; in 2016, Wang et al. established a JND model for screen image rebuilt based on the edge contour, which decomposed the calculations of edge contour-based JND threshold into independent estimations of adaptive illumination and masking effects and structured masking effect; Hadizadeh et al. incorporated factors like visual attention mechanism to propose a JND model. Frequency domain-based JND models mainly consider Contrast Sensitivity Function (CSF), Contrast Masking Effect, Adaptive Illumination Effect, and Fovea Centralis Retinae Masking Effect. For example, In the temporal and spatial CSF-based JND model introduced by Z. Wei et al. in 2009, gamma coefficient was introduced to compensate illumination effect; Bae et al. took into account the influence of different frequencies on adaptive illumination, and thus proposed a new adaptive illumination-based JND model; By means of computational complexity theory, H. Ko et al. calculated contrast masking effect, and established a JND model in 2014 that could adapt to the core of Discrete Cosine Transform (DCT) of any size; Ki et al. considered the impact of quantification-induced energy losses on JND threshold during the compression process, and hence put forward a learning-based JND predicting method in 2018.

Currently, pixel domain-based JND models are used to calculate a JND threshold for each image pixel, while frequency domain-based JND models can be adopted to first convert the image's pixel domain into its frequency domain and then calculate a JND threshold for each sub-frequency. Thus, it can be seen that both pixel domain-based and frequency domain-based JND models are local JND threshold estimation models which just estimate the JND threshold of a single pixel or frequency. However, the quality of the entire image is determined by some key regions and poor regions, so it is difficult for the above two kinds of JND models to accurately estimate human eyes' JND threshold for the entire image; moreover, traditional JND models mainly took into account the estimations of JND thresholds of raw images but failed to estimate the JND thresholds of the image of any quality level. Since the images or videos received by the image or video processing systems in real life are mostly distorted ones, the practical application of traditional JND models is subject to restrictions. As such, it is of great significance to predict the JND threshold for the image of any quality level.

### SUMMARY OF THE INVENTION

The invention provides a prediction method, device, equipment, and storage medium for the image-level JND threshold, aiming to eliminate a huge deviation in the prediction of the JND threshold for the entire image because an effective prediction method for the image-level JND threshold is not available based on current technologies.

On the one hand, the invention provides a prediction method for the image-level JND threshold, and the said method can be explained in the following steps:

Perceptual distortion discrimination is conducted on the raw image and on the compressed images in the compressed image set of the said image through trained multi-class perceptual distortion discriminator to obtain the set of perceptual distortion discrimination results, where perceptual distortion discrimination results consist of true values and false values;

Preset image-level JND search strategies are adopted for fault tolerance of the said set of perceptual distortion discrimination results, thus predicting the image-level JND threshold of the said image.

On the other hand, the invention provides a prediction device for the image-level JND threshold, and the said device consists of:

A perceptual distortion discrimination unit, wherein perceptual distortion discrimination is conducted on the raw image and on the compressed images in the compressed image set of the said image through trained multi-class perceptual distortion discriminator to obtain the set of perceptual distortion discrimination results, where perceptual distortion discrimination results consist of true values and false values; and

A JND threshold prediction unit, wherein preset image-level JND search strategies are adopted for fault tolerance of the said set of perceptual distortion discrimination results, thus predicting the image-level JND threshold of the said image.

On the other hand, the invention also provides a computing device, comprising a memory, a processor, and a computer program stored in the said memory and executable in the said processor, wherein the said steps for the prediction method of the above image-level JND threshold are effectuated when the said computer program is executed by the said processor.

On the other hand, the invention also provides a computer-readable storage medium in which the computer program is stored, wherein the said steps for the prediction method of the above image-level JND threshold are effectuated when the said computer program is executed by the said processor.

In this invention, perceptual distortion discrimination is conducted on the raw image and on the compressed images in the compressed image set of the said image through trained multi-class perceptual distortion discriminator to obtain the set of perceptual distortion discrimination results, and preset image-level JND search strategies are adopted for fault tolerance of the said set of perceptual distortion discrimination results to predict the image-level JND threshold of the said image, thus reducing the prediction deviation of the image-level JND threshold, improving the prediction accuracy of the image-level JND threshold, and bringing the predicted JND threshold closer to the human visual system's perception of the quality of the entire image.

### BRIEF DESCRIPTION OF FIGURES

FIG. 1 gives the flow chart on how the prediction method for the image-level JND threshold is effectuated as hereunder provided by Embodiment I of the invention;

FIG. 2 gives the flow chart on how perceptual distortion discrimination is effectuated on the raw image and compressed images as hereunder provided by Embodiment II of the invention;

FIG. 3 gives the flow chart on how fault tolerance is effectuated on the set of perceptual distortion discrimination results as hereunder provided by Embodiment III of the invention;

FIG. 4 shows a schematic view of the sliding window as hereinbefore provided by Embodiment III of the invention;

FIG. 5 shows a schematic view of the prediction device for the image-level JND threshold as hereunder provided by Embodiment IV of the invention;

FIG. 6 shows a schematic view of the prediction device for the image-level JND threshold as hereunder provided by Embodiment V of the invention; and

FIG. 7 shows a schematic view of the computing device as hereunder provided by Embodiment VI of the invention.

### DETAILED DESCRIPTION OF THE INVENTION

In order to present the objects, technical solutions, and advantages of the invention in a clearer way, the invention is further detailed in combination with the appended figures and embodiments below. It should be understood that specific embodiments described herein just serve the purpose of explaining the invention instead of imposing restrictions on it.

In the following part, specific embodiments are presented for a more detailed description of the invention:

### Embodiment I

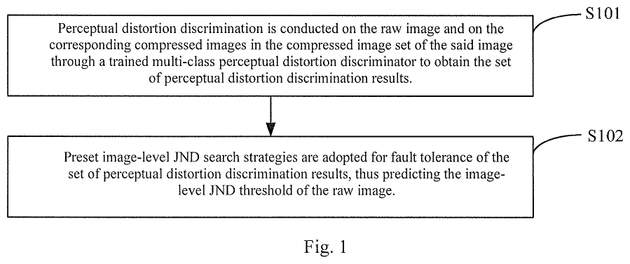

FIG. 1 gives the flow chart on how the prediction method for the image-level JND threshold is effectuated as provided by Embodiment I of the invention. For clarification, only some processes regarding this embodiment of the invention are displayed, as detailed below:

In S101, perceptual distortion discrimination is conducted on the raw image and on the corresponding compressed images in the compressed image set of the said image through a trained multi-class perceptual distortion discriminator to obtain the set of perceptual distortion discrimination results.

This embodiment of the invention applies to image/video processing platforms, systems, or devices, such as personal computers and servers. In this embodiment of the invention, the raw image is compressed through different compression ways to obtain compressed images of different quality levels, and all compressed images of different quality levels form a compressed image set. By entering the raw image x and the i^{th} compressed image xᵢ in the compressed image set of the said image x into the trained multi-class perceptual distortion discriminator, perceptual distortion discrimination is effectuated on the raw image x and the i^{th} compressed image xᵢ through the trained multi-class perceptual distortion discriminator to get perceptual distortion discrimination results, and all these results form a set of perceptual distortion discrimination results, wherein perceptual distortion discrimination results consist of true values (such as 1) and false values (such as 0).

Before implementing perceptual distortion discrimination on the raw image and on the corresponding compressed image in the compressed image set of the raw image through the trained multi-class perceptual distortion discriminator, preferably, a multi-class perceptual distortion discriminator is constructed, and supervised, half-supervised or unsupervised image training samples are adopted for training the multi-class perceptual distortion discriminator, thus making it possible for the multi-class perceptual distortion discriminator to distinguish between two images of the same content but with different quality levels about whether there is any perceptual distortion.

While training the trained multi-class perceptual distortion discriminator, preferably, a binary perceptual quality discriminator is constructed by means of Convolutional Neural Network, Linear Regression Function, and Logistic Regression Function, so a multi-class perceptual distortion discriminator is built based on this binary perceptual quality discriminator; the learning is conducted on this binary perceptual quality discriminator in accordance with pre-generated training image samples; the first parameter set of Convolutional Neural Network, the second parameter set of Linear Regression Function and the third parameter set of Logistic Regression Function are adjusted based on the sample labels of training image samples, so as to make use of the learned binary perceptual quality discriminator, and realize the perceptual distortion discrimination between the raw image and the corresponding compressed image in the compressed image set of the raw image, thus decomposing the training of the multi-class perceptual distortion discriminator into the training of the binary perceptual quality discriminator and improving the training speed and efficiency of the discriminator model.

While the learning is conducted on the binary perceptual quality discriminator based on pre-generated training image samples, preferably, the learning of the binary perceptual quality discriminator is achieved through the following steps:

1) A predetermined number (such as 50) of training image samples are generated from MCL_JCI Dataset, and the training image samples comprise positive and negative image samples, marked as {xₜ, yₜ}, wherein xₜ is the sample image data, xₜ consists of raw image sample and its corresponding compressed image sample set, and yₜ is the sample label of the sample image data;

2) The raw image sample x and the i^{th} compressed image sample xᵢ in the compressed image sample set of the said raw image sample are respectively divided into image blocks with a size of M×M, and the j^{th} image blocks of x and xᵢ are respectively marked as P_{x,j} and P_{xi,j}, wherein j∈[1, 2, . . . S/M], S is the size of the raw image sample x, and the image blocks of raw image samples and compressed image samples are arranged in the same sequence;

3) N image blocks at the same positions are chosen from the blocks divided by x and xᵢ, respectively, marked as raw sample image block set {P_{x,1}, P_{x,2}, . . . , P_{xN}}, and compressed sample image block set {P_{xi,1}, P_{xi,2}, . . . , P_{xi,N}};

4) Convolutional Neural Network (CNN) is adopted for feature extraction of raw sample image blocks and compressed sample image blocks in {P_{x,1}, P_{x,2}, . . . , P_{x,N}} and {P_{xi,1}, P_{xi,2}, . . . , P_{xi,N}}, respectively, to obtain corresponding raw sample image block feature set and compressed sample image block feature set, marked as {F_{x, 1}, F_{x,2}, . . . , F_{x,N}} and {F_{xi,1}, F_{xi,2}, . . . , F_{xi,N}};

5) Feature fusion is implemented on the lth raw sample image block feature F_{x,1} and its corresponding compressed sample image block feature F_{xi,1} in {F_{x,1}, F_{x,2}, . . . , F_{x,N}} and {F_{xi,1}, F_{xi,2}, . . . , F_{xi,N}} through the feature fusion ways {F_{x,j},F_{xi,j}}, {F_{x,j}-F_{xi,j}} or {F_{x,j},F_{xi,j},F_{x,j}-F_{xi,j}}, respectively, thus obtaining sample fused feature set {F′₁, F′₂, . . . , F′_{N}};

6) Based on the sample fused feature set {F′₁, F′₂, . . . , F′_{N}}, Linear Regression Function is adopted for scoring the quality of every compressed sample image block in {P_{xi,1}, P_{xi,2}, . . . , P_{xi,N}} and obtaining the corresponding sample quality score set {S₁, S₂, . . . , S_{N}};

7) The value mapped from {S₁, S₂, . . . , S_{N}} to 0 or 1 through Logistic Regression Function is marked as r: when r≥0.5, it is considered that there is a perceptual distortion between the compared image sample xᵢ and the raw image sample x, thus obtaining perceptual distortion discrimination results and judging whether these perceptual distortion discrimination results are consistent with corresponding sample labels. If not consistent, the first parameter set of Convolutional Neural Network, the second parameter set of Linear Regression Function and the third parameter set of Logistic Regression Function are adjusted, and we skip to Step 4) to continue with the learning of the binary perceptual quality discriminator until perceptual distortion discrimination results are consistent with corresponding sample labels or the learning times reach the preset iterative threshold.

In this embodiment of the invention, the training of multi-class perceptual distortion discriminator is converted into the training of binary perceptual quality discriminator based on Steps 1)-7), thus improving the training speed and efficiency of multi-class perceptual distortion discriminator and lowering the difficulty in predicting subsequent image-level JND thresholds.

Before the learning of the binary perceptual quality discriminator based on the pre-generated training image samples, preferably, the learning efficiency is initialized into 1×10⁻⁴, and Adam Algorithm is adopted as the gradient descent method; also, the mini-batch gradient descent is set as 4 to process one mini-batch; then, the first parameter set, the second parameter set, and the third parameter set are updated to improve the training speed and efficiency of multi-class perceptual distortion discriminator.

In S102, preset image-level JND search strategies are adopted for fault tolerance of the set of perceptual distortion discrimination results, thus predicting the image-level JND threshold of the raw image.

In this embodiment of the invention, there may be erroneous perceptual distortion discrimination on the raw image and on the compressed images through the multi-class perceptual distortion discriminator, thus obtaining inaccurate perceptual distortion discrimination results. Therefore, preset image-level JND search strategies are adopted for fault tolerance of the set of perceptual distortion discrimination results to ultimately predict the image-level JND threshold of the said image, thus improving the prediction accuracy of the image-level JND threshold.

In this embodiment of the invention, perceptual distortion discrimination is conducted on the raw image and on the compressed images in the compressed image set of the said image through trained multi-class perceptual distortion discriminator to obtain the set of perceptual distortion discrimination results, and preset image-level JND search strategies are adopted for fault tolerance of the said set of perceptual distortion discrimination results to predict the image-level JND threshold of the said image, thus reducing the prediction deviation of the image-level JND threshold, improving the prediction accuracy of the image-level JND threshold, and bringing the predicted JND threshold closer to the human visual system's perception of the quality of the entire image.

### Embodiment II

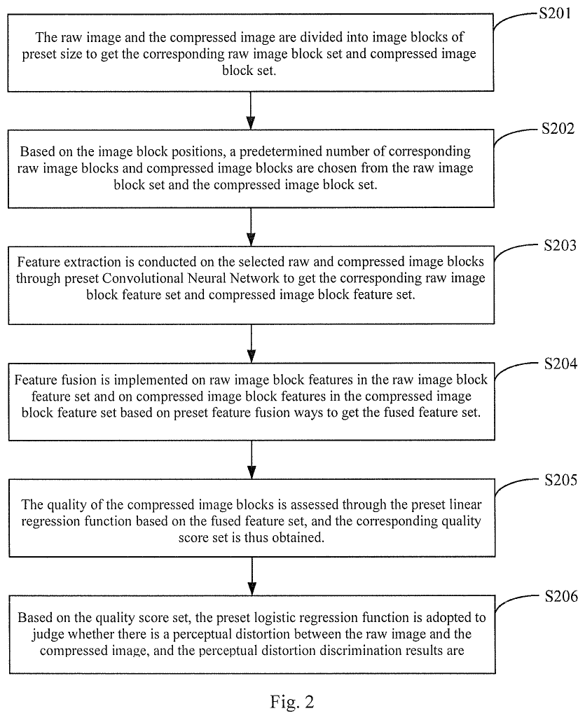

FIG. 2 gives the flow chart on how the perceptual distortion discrimination is effectuated on the raw image and the compressed image in S101 of Embodiment I as provided by Embodiment II of the invention. For clarification, only some processes regarding this embodiment of the invention are displayed, as detailed below:

In S201, the raw image and the compressed image are divided into image blocks of preset size to get the corresponding raw image block set and compressed image block set.

In this embodiment of the invention, the raw image x and the ith compressed image xᵢ of the raw image are divided into image blocks of preset size to get the corresponding raw image block set and compressed image block set, where the raw image blocks and the compressed image blocks are arranged in the same sequence. For example, for the jth raw image block P_{x,j} divided by the raw image x, the image block divided by the compressed image xᵢ at the same position with the raw image block P_{x,j} at the raw image x is called P_{x,j}, namely, the jth compressed image block.

Preferably, the image block size is determined as 32×32, thus avoiding oversize or undersize image block, which may reduce the efficiency of feature extraction for subsequent image blocks.

In S202, based on the image block positions, a predetermined number of corresponding raw image blocks and compressed image blocks are chosen from the raw image block set and the compressed image block set, respectively.

In this embodiment of the invention, a predetermined number of corresponding raw image blocks and compressed image blocks are randomly selected from the raw image block set and the compressed image block set, respectively, and the selected raw image blocks in the raw image are arranged at the same positions with the selected compressed image blocks in the compressed image.

Preferably, the quantities of the selected raw image blocks and the selected compressed image blocks are both 32, thus avoiding excessive or inadequate image blocks for feature extraction, which may reduce the efficiency of feature extraction for subsequent image blocks.

In S203, feature extraction is conducted on the selected raw image blocks and compressed image blocks through preset Convolutional Neural Network to get the corresponding raw image block feature set and compressed image block feature set.

In this embodiment of the invention, preferably, the Convolutional Neural Network's network structure comprises an activated layer immediately following each convolutional layer and a pooling layer between every two convolutional layers, thus enhancing the distinctiveness of the features extracted from raw image blocks and compressed image blocks.

Further preferably, the Convolutional Neural Network has ten convolutional layers, a convolutional kernel size of 3, and a convolutional step size of 2, thus further enhancing the distinctiveness of the features extracted from raw image blocks and compressed image blocks.

Again, preferably, Rectified linear unit (ReLU) is adopted for the activation function of the Convolutional Neural Network, and the maximum pooling method is adopted for the pooling, thus improving the calculation and convergence speeds of the Convolutional Neural Network.

In S204, feature fusion is implemented on raw image block features in the raw image block feature set and on compressed image block features in the compressed image block feature set based on preset feature fusion ways to get the fused feature set.

In this embodiment of the invention, feature fusion is conducted on the lth raw image block feature F_{x,1} in the raw image block feature set {F_{x,1}, F_{x,2}, . . . , F_{x,N}} and the corresponding compressed image block feature F_{x,1} in the compressed image block feature set {F_{xi,1}, F_{xi,2}, . . . , F_{xi,N}} through the feature fusion methods {F_{x,j},F_{xi,j}}, {F_{x,j}-F_{xi,j}} or {F_{x,j},F_{xi,j},F_{x,j}-F_{xi,j}}, and the fused feature set {F′₁, F′₂, . . . , F′_{N}} is thus obtained, wherein N is the number of the selected raw and compressed image blocks.

Preferably, the feature fusion method {F_{x,j},F_{xi,j},F_{x,j}-F_{xi,j}} is adopted for the fusion of raw image block features and corresponding compressed image block features, thus improving the distinctiveness of features.

In S205, the quality of compressed image blocks is assessed through the preset linear regression function based on the fused feature set, and the corresponding quality score set is thus obtained.

In this embodiment of the invention, the quality of each compressed image block in the compressed image block set is assessed through any linear regression function (such as Support Vector Machine (SVM)) based on the fused feature set, and corresponding quality scores are obtained. For example, the quality score of the j^{th} compressed image block P_{xi,j} is marked as Sⱼ, and the quality scores of all compressed image blocks form the quality score set, marked as {S₁, S₂, . . . , S_{N}}.

In this embodiment of the invention, preferably, Multi-layer Perception (MLP) is adopted as the linear regression function, and the number of layers for the Multi-layer Perception is set as 1, thus improving the accuracy of quality scoring.

In S206, based on the quality score set, the preset logistic regression function is adopted to judge whether there is a perceptual distortion between the raw image and the compressed image, and the perceptual distortion discrimination results are obtained.

In this embodiment of the invention, the quality score set {S₁, S₂, . . . , S_{N}} for compressed image blocks is obtained. By adopting the logistic regression function

$$Ψ ( {\sum }_{i = 1}^{N} {w}_{i} {S}_{i} + b ) ,$$

the value mapped from {S₁, S₂, . . . , S_{N}} to 0 or 1 is marked as r: when r≥0.5, it is believed that there is a perceptual distortion between the compressed image xᵢ and the raw image x, and the true value (1) is outputted; otherwise, it is held that there is no perceptual distortion between xᵢ and x, and the false value (0) is outputted, wherein N is the number of the selected raw and compressed image blocks; ψ(⋅) is sig mod function; wᵢ is the weight of the i^{th} compressed image block; the weights of all compressed image blocks form the third parameter set of the Logistic Regression Function; b is the offset parameter of the Logistic Regression Function.

In this embodiment of the invention, the raw image and compressed image are firstly divided into image blocks; then, feature extraction and feature fusion are organized for the divided raw and compressed image blocks; finally, the quality of the compressed image block is assessed based on the fused features, and the perceptual distortion discrimination results of the compressed image and raw image are obtained, thus enhancing the accuracy of perceptual distortion discrimination results.

### Embodiment III

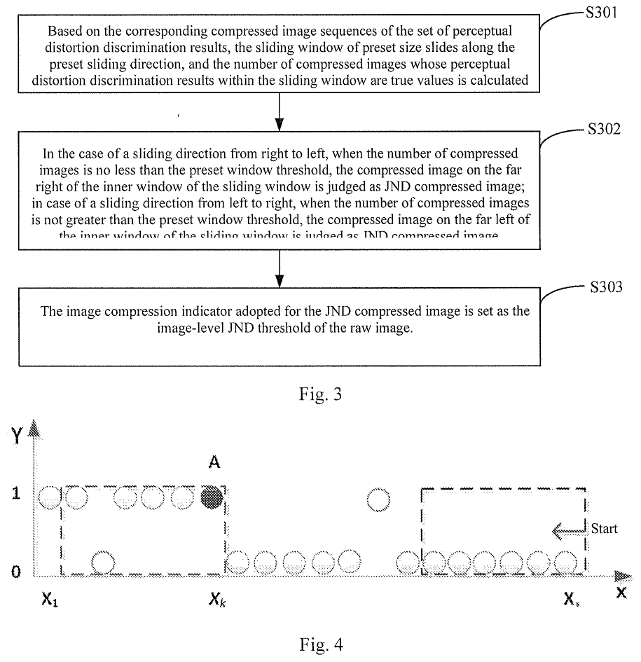

FIG. 3 gives the flow chart on how the fault tolerance is effectuated on the perceptual distortion discrimination results in S102 of Embodiment I as provided by Embodiment III of the invention. For clarification, only some processes regarding this embodiment of the invention are displayed, as detailed below:

In S301, based on the corresponding compressed image sequences of the set of perceptual distortion discrimination results, the sliding window of preset size slides along the preset sliding direction, and the number of compressed images whose perceptual distortion discrimination results within the sliding window are true values is calculated, wherein the sliding director is from right to left or from left to right.

In this embodiment of the invention, each perceptual distortion discrimination result in the perceptual distortion discrimination result set corresponds to a compressed image, and the compressed image sequences x₁, x₂, . . . x_{N} corresponding to the perceptual distortion discrimination result set constitute an XY coordinate system together with the perceptual distortion discrimination results, where the compressed image sequences x₁, x₂, . . . x_{N} form the coordinates along X-axis; the true value (1) and the false value (0) of perceptual distortion discrimination results form the coordinates along Y-axis; the sliding window of preset size begins to slide from the last compressed image (namely, the Nth compressed image x_{N}) on the right of X-axis in the coordinate system to the origin on the left of the XY coordinate system (namely, sliding along X-axis from right to left), or the sliding window starts to slide from the first compressed image (namely, the 1st compressed image x₁) on the X-axis close to the origin of the coordination system to the right along X-axis (namely, sliding along X-axis from left to right); during the sliding process, the number of compressed images whose perceptual distortion discrimination results within the sliding window are true values is calculated, namely, calculating how many compressed images within the sliding window are found with perceptual distortion discrimination results that belong to true values.

As an example, as shown in FIG. 4 where the schematic view of the sliding window sliding along the X-axis from right to left is presented, the compressed image sequences x₁, x₂, . . . x_{N} corresponding to the perceptual distortion discrimination result set constitute the coordinates of X-axis in the XY coordinate system in FIG. 4, while the true value (1) and the false value (0) of perceptual distortion discrimination results form the coordinates along Y-axis; the sliding window begins to slide from the last compressed image (namely, the Nth compressed image x_{N}) on the right of X-axis in the coordinate system to the origin on the left of the XY coordinate system.

Before sliding the sliding window of preset size from right to left, preferably, the size of the sliding window is set as 6, thus enhancing the success rate of correcting erroneous results in the perceptual distortion discrimination result set.

In S302, in case of a sliding direction from right to left, when the number of compressed images is no less than the preset window threshold, the compressed image on the far right of the inner window of the sliding window is judged as JND compressed image; in case of a sliding direction from left to right, when the number of compressed images is not greater than the preset window threshold, the compressed image on the far left of the inner window of the sliding window is judged as JND compressed image.

In this embodiment of the invention, in case of a sliding direction from right to left, it is judged whether the number of compressed images whose perceptual distortion discrimination results within the sliding window are true values is greater than or equal to the preset window threshold; if yes, the sliding window stops sliding, and the compressed image on the far right of the inner window of the sliding window is judged as JND compressed image, as suggested by the kth compressed image xₖ at Point A in FIG. 4; otherwise, the sliding window continues to slide until the number of compressed images whose perceptual distortion discrimination results within the sliding window are true values is greater than or equal to the preset window threshold. In the case of a sliding direction from left to right, it is judged whether the number of compressed images whose perceptual distortion discrimination results within the sliding window are true values is less than or equal to the preset window threshold; if yes, the sliding window stops sliding, and the compressed image on the far left of the inner window of the sliding window is judged as JND compressed image; otherwise, the sliding window continues to slide until the number of compressed images whose perceptual distortion discrimination results within the sliding window are true values is less than or equal to the preset window threshold.

Preferably, the size of the preset window threshold is set as 5, thus enhancing the success rate of correcting erroneous results in the perceptual distortion discrimination result set.

In S303, the image compression indicator adopted for JND compressed image is set as the image-level JND threshold of the raw image.

In this embodiment of the invention, JND compressed image (namely, the kth compressed image xₖ) is obtained by compressing the raw image with the corresponding image compression indicator, and the compression factor, bit rate, or other image quality indicator (such as Peak Signal to Noise Ratio (PSNR)) adopted for the compressed image xₖ during the compression process is used as the JND threshold of the raw image.

In this embodiment of the invention, the image-level JND search strategies based on the sliding window are adopted for fault tolerance, and the image-level JND threshold of the raw image is predicted, thus improving the accuracy of the prediction of the image-level JND threshold.

### Embodiment IV

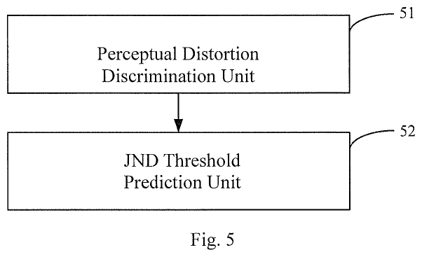

FIG. 5 shows a schematic view of the prediction device for the image-level JND threshold as provided in Embodiment IV of the invention. For clarification, only some parts regarding this embodiment of the invention are displayed, comprising:

A perceptual distortion discrimination unit 51, wherein perceptual distortion discrimination is conducted on the raw image and on the corresponding compressed images in the compressed image set of the said image through a trained multi-class perceptual distortion discriminator to obtain the set of perceptual distortion discrimination results; and

A JND threshold prediction unit 52, wherein preset image-level JND search strategies are adopted for fault tolerance of the set of perceptual distortion discrimination results, thus predicting the image-level JND threshold of the raw image.

In this embodiment of the invention, various units of the prediction device for the image-level JND threshold can be achieved through corresponding hardware or software units, while various units can serve as independent software or hardware units or can be integrated into a software and hardware unit, wherein the invention is not restricted in this respect. Specifically, the embodiments of various units have been described in the hereinbefore embodiments and will not be elaborated again here.

### Embodiment V

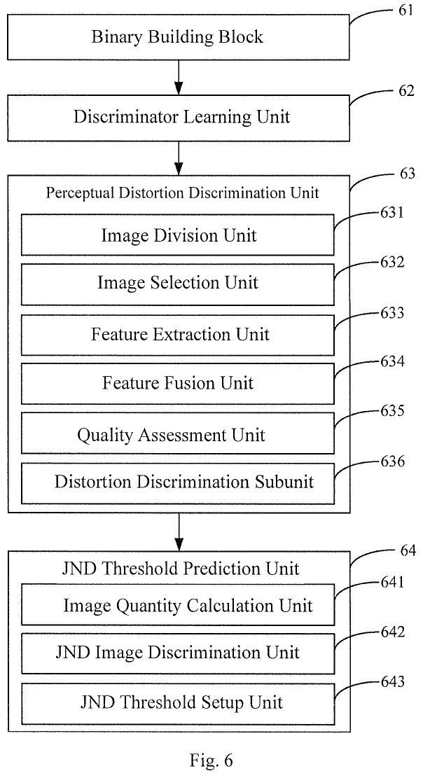

FIG. 6 shows a schematic view of the prediction device for the image-level JND threshold as provided in Embodiment V of the invention. For clarification, only some parts regarding this embodiment of the invention are displayed, comprising:

A binary building block 61, wherein Convolutional Neural Network, Linear Regression Function, and Logistic Regression Function are adopted for constructing a binary perceptual quality discriminator so as to make the multi-class perceptual distortion discriminator with this binary perceptual quality discriminator;

A discriminator learning unit 62, wherein pre-generated training image samples are adopted for the learning of the binary perceptual quality discriminator, and the first parameter set of Convolutional Neural Network, the second parameter set of Linear Regression Function and the third parameter set of Logistic Regression Function are adjusted based on the sample labels of training image samples so that the learned binary perceptual quality discriminator is utilized for perceptual distortion discrimination between the raw images and the compressed images in the compressed image set;

A perceptual distortion discrimination unit 63, wherein perceptual distortion discrimination is conducted on the raw image and on the corresponding compressed images in the compressed image set of the said image through a trained multi-class perceptual distortion discriminator to obtain the set of perceptual distortion discrimination results; and

A JND threshold prediction unit 64, wherein preset image-level JND search strategies are adopted for fault tolerance of the set of perceptual distortion discrimination results, thus predicting the image-level JND threshold of the raw image.

Wherein, preferably, a perceptual distortion discrimination unit 63 comprises:

An image block division unit 631, wherein the raw image and the compressed image are divided into image blocks of preset size to get the corresponding raw image block set and compressed image block set;

An image block selection unit 632, wherein based on the image block positions, a predetermined number of corresponding raw image blocks and compressed image blocks are chosen from the raw image block set and the compressed image block set, respectively;

A feature extraction unit 633, wherein feature extraction is conducted on the selected raw image blocks and compressed image blocks through preset Convolutional Neural Network to get the corresponding raw image block feature set and compressed image block feature set;

A feature fusion unit 634, wherein feature fusion is implemented on raw image block features in the raw image block feature set and on compressed image block features in the compressed image block feature set based on preset feature fusion ways to get the fused feature set;

A quality assessment unit 635, wherein the quality of compressed image blocks is assessed through the preset linear regression function based on the fused feature set, and the corresponding quality score set is thus obtained; and

A distortion discrimination subunit 636, wherein based on the quality score set, the preset logistic regression function is adopted to judge whether there is a perceptual distortion between the raw image and the compressed image, and the perceptual distortion discrimination results are obtained.

A JND threshold prediction unit 64 consists of:

An image quantity calculation unit 641, wherein based on the corresponding compressed image sequences of the set of perceptual distortion discrimination results, the sliding window of preset size slides along the preset sliding direction, and the number of compressed images whose perceptual distortion discrimination results within the sliding window are true values is calculated, wherein the sliding director is from right to left or from left to right;

A JND image discrimination unit 642, wherein in case of a sliding direction from right to left, when the number of compressed images is no less than the preset window threshold, the compressed image on the far right of the inner window of the sliding window is judged as JND compressed image; in case of a sliding direction from left to right, when the number of compressed images is not greater than the preset window threshold, the compressed image on the far left of the inner window of the sliding window is judged as the said JND compressed image; and

A JND threshold setup unit 643, wherein the image compression indicator adopted for JND compressed image is set as the image-level JND threshold of the raw image.

In this embodiment of the invention, various units of the prediction device for the image-level JND threshold can be achieved through corresponding hardware or software units, while various units can serve as independent software or hardware units or can be integrated into a software and hardware unit, wherein the invention is not restricted in this respect. Specifically, the embodiments of various units have been described in the hereinbefore embodiments and will not be elaborated again here.

### Embodiment VI

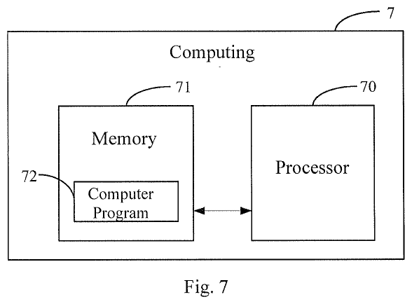

FIG. 7 shows a schematic view of the computing device as provided in Embodiment VI of the invention. For clarification, only some parts regarding this embodiment of the invention are displayed.

In this embodiment of the invention, the computing device 7 consists of a processor 70, a memory 71, and a computer program 72 stored in memory 71 and executable on the processor 70. When processor 70 executes the computer program 72, the steps in the hereinbefore embodiments of the prediction method for the image-level JND threshold are effectuated, such as S101 or S102 in FIG. 1. Alternatively, when processor 70 executes the computer program 72, the functions of various units in the hereinbefore device embodiments are effectuated, such as the functions of Unit 51 and Unit 52 in FIG. 5.

In this embodiment of the invention, perceptual distortion discrimination is conducted on the raw image and on the compressed images in the compressed image set of the said image through trained multi-class perceptual distortion discriminator to obtain the set of perceptual distortion discrimination results, and preset image-level JND search strategies are adopted for fault tolerance of the said set of perceptual distortion discrimination results to predict the image-level JND threshold of the said image, thus reducing the prediction deviation of the image-level JND threshold, improving the prediction accuracy of the image-level JND threshold, and bringing the predicted JND threshold closer to the human visual system's perception of the quality of the entire image.

The computing device in this embodiment of the invention consists of a personal computer and a server. When the processor 70 in the computing device 7 executes the computer program 72, the steps of effectuating the prediction method for the image-level JND threshold have been described in the hereinbefore method embodiments and will not be further elaborated here.

### Embodiment VII

In this embodiment of the invention, a computer-readable storage medium is presented, provided with a computer program. When the computer program is executed by the processor, the steps in the prediction method embodiments for the image-level JND threshold are effectuated, such as S101 and S102 in FIG. 1. Alternatively, when the computer program is executed by the processor, the functions of various units in the hereinbefore device embodiments are effectuated, such as the functions of Unit 51 and Unit 52 in FIG. 5.

In this embodiment of the invention, perceptual distortion discrimination is conducted on the raw image and on the compressed images in the compressed image set of the said image through trained multi-class perceptual distortion discriminator to obtain the set of perceptual distortion discrimination results, and preset image-level JND search strategies are adopted for fault tolerance of the said set of perceptual distortion discrimination results to predict the image-level JND threshold of the said image, thus reducing the prediction deviation of the image-level JND threshold, improving the prediction accuracy of the image-level JND threshold, and bringing the predicted JND threshold closer to the human visual system's perception of the quality of the entire image.

In this embodiment of the invention, the computer-readable storage medium comprises any physical device or recording medium, such as ROM/RAM, disc, compact disc, flash memory, and other memories.

The said embodiments just represent the best embodiments of this invention, but do not serve the purpose of restricting this invention; any revision, equivalent replacement, or improvement made within the spirit and principle of this invention is included in the protection scope of this invention.

1. A prediction method for the image-level JND threshold, characterized by the said method comprising the following steps:
Perceptual distortion discrimination is conducted on the raw image and on the compressed images in the compressed image set of the said image through trained multi-class perceptual distortion discriminator to obtain the set of perceptual distortion discrimination results, where perceptual distortion discrimination results consist of true values and false values;
Preset image-level JND search strategies are adopted for fault tolerance of the said set of perceptual distortion discrimination results, thus predicting the image-level JND threshold of the said image.

2. A method as claimed in claim 1, characterized in that perceptual distortion discrimination is conducted on the raw image and on the corresponding compressed images in the compressed image set of the said raw image through a trained multi-class perceptual distortion discriminator, whose steps comprise:
The said raw image and the said compressed image are divided into image blocks of preset size to get the corresponding raw image block set and compressed image block set;
Based on the image block positions, a predetermined number of corresponding raw image blocks and compressed image blocks are chosen from the said raw image block set and the said compressed image block set;
Feature extraction is conducted on the said selected raw and compressed image blocks through preset Convolutional Neural Network to get the corresponding raw image block feature set and compressed image block feature set;
Feature fusion is implemented on raw image block features in the said raw image block feature set and on compressed image block features in the said compressed image block feature set based on preset feature fusion ways to get the fused feature set;
The quality of the said compressed image blocks is assessed through the preset linear regression function based on the said fused feature set, and the corresponding quality score set is thus obtained;
Based on the said quality score set, the preset logistic regression function is adopted to judge whether there is a perceptual distortion between the said raw image and the said compressed image, and the said perceptual distortion discrimination results are obtained.

3. A method as claimed in claim 2, characterized in that before perceptual distortion discrimination is conducted on the raw image and on the corresponding compressed images in the compressed image set of the said raw image through a trained multi-class perceptual distortion discriminator, the said method also comprises:
The said Convolutional Neural Network, the said Linear Regression Function, and the said Logistic Regression Function are adopted for constructing a binary perceptual quality discriminator so as to make the said multi-class perceptual distortion discriminator with the said binary perceptual quality discriminator;
Pre-generated training image samples are adopted for the learning of the said binary perceptual quality discriminator, and the first parameter set of the said Convolutional Neural Network, the second parameter set of the said Linear Regression Function, and the third parameter set of the said Logistic Regression Function are adjusted based on the said sample labels of training image samples so that the learned binary perceptual quality discriminator is utilized for perceptual distortion discrimination between the said raw images and the said compressed images in the compressed image set.

4. A method as claimed in claim 1, characterized in that preset image-level JND search strategies are adopted for fault tolerance of the said set of perceptual distortion discrimination results, whose steps comprise:
Based on the corresponding compressed image sequences of the said set of perceptual distortion discrimination results, the sliding window of preset size slides along the preset sliding direction, and the number of compressed images whose said perceptual distortion discrimination results within the said sliding window are true values is calculated, wherein the said sliding director is from right to left or from left to right;
In the case of the said sliding direction from right to left, when the number of the said compressed images is no less than the preset window threshold, the compressed image on the far right of the inner window of the said sliding window is judged as JND compressed image; in case of the said sliding direction from left to right, when the number of the said compressed images is not greater than the said preset window threshold, the compressed image on the far left of the inner window of the said sliding window is judged as the said JND compressed image;
The image compression indicator adopted for the said JND compressed image is set as the image-level JND threshold of the said raw image.

5. A prediction device for the image-level JND threshold, characterized in that the said device comprises:
A perceptual distortion discrimination unit, wherein perceptual distortion discrimination is conducted on the raw image and on the compressed images in the compressed image set of the said image through trained multi-class perceptual distortion discriminator to obtain the set of perceptual distortion discrimination results, where perceptual distortion discrimination results consist of true values and false values; and a JND threshold prediction unit, wherein preset image-level JND search strategies are adopted for fault tolerance of the said set of perceptual distortion discrimination results, thus predicting the image-level JND threshold of the said raw image.

6. A device as claimed in claim 5, characterized in that the said perceptual distortion discrimination unit comprises:
An image block division unit, wherein the said raw image and the said compressed image are divided into image blocks of preset size to get the corresponding raw image block set and compressed image block set;
An image block selection unit, wherein based on the image block positions, a predetermined number of corresponding raw image blocks and compressed image blocks are chosen from the said raw image block set and the said compressed image block set, respectively;
A feature extraction unit, wherein feature extraction is conducted on the said selected raw and compressed image blocks through preset Convolutional Neural Network to get the corresponding raw image block feature set and compressed image block feature set;
A feature fusion unit, wherein feature fusion is implemented on raw image block features in the said raw image block feature set and on compressed image block features in the said compressed image block feature set based on preset feature fusion ways to get the fused feature set;
A quality assessment unit, wherein the quality of the said compressed image blocks is assessed through the preset linear regression function based on the said fused feature set, and the corresponding quality score set is thus obtained; and
A distortion discrimination subunit, wherein based on the said quality score set, the preset logistic regression function is adopted to judge whether there is a perceptual distortion between the said raw image and the said compressed image, and the said perceptual distortion discrimination results are obtained.

7. A device as claimed in claim 6, characterized in that the said device also comprises:
A binary building block, wherein the said Convolutional Neural Network, the said Linear Regression Function, and the said Logistic Regression Function are adopted for constructing a binary perceptual quality discriminator so as to make the said multi-class perceptual distortion discriminator with the said binary perceptual quality discriminator; and
A discriminator learning unit, wherein pre-generated training image samples are adopted for the learning of the said binary perceptual quality discriminator, and the first parameter set of the said Convolutional Neural Network, the second parameter set of the said Linear Regression Function, and the third parameter set of the said Logistic Regression Function are adjusted based on the said sample labels of training image samples so that the learned binary perceptual quality discriminator is utilized for perceptual distortion discrimination between the said raw images and the said compressed images in the compressed image set.

8. A device as claimed in claim 5, characterized in that the said JND threshold prediction unit comprises:
An image quantity calculation unit, wherein based on the corresponding compressed image sequences of the said set of perceptual distortion discrimination results, the sliding window of preset size slides along the preset sliding direction, and the number of compressed images whose said perceptual distortion discrimination results within the said sliding window are true values is calculated, wherein the said sliding director is from right to left or from left to right;
A JND image discrimination unit, wherein in case of the said sliding direction from right to left, when the number of the said compressed images is no less than the preset window threshold, the compressed image on the far right of the inner window of the said sliding window is judged as JND compressed image; in case of the said sliding direction from left to right, when the number of the said compressed images is not greater than the said preset window threshold, the compressed image on the far left of the inner window of the said sliding window is judged as the said JND compressed image; and
A JND threshold setup unit, wherein the image compression indicator adopted for the said JND compressed image is set as the image-level JND threshold of the said raw image.

9. A computing device, comprising a memory, a processor, and a computer program stored in the said memory and executed in the said processor, characterized in that the steps as claimed in claim 1 are effectuated when the said computer program is executed by the said processor.

10. A computer-readable storage medium in which the computer program is stored, characterized in that the steps as claimed in claim 1 are effectuated when the said computer program is executed by the said processor.

11. A computing device, comprising a memory, a processor, and a computer program stored in the said memory and executed in the said processor, characterized in that the steps as claimed in claim 2 are effectuated when the said computer program is executed by the said processor.

12. A computing device, comprising a memory, a processor, and a computer program stored in the said memory and executed in the said processor, characterized in that the steps as claimed in claim 3 are effectuated when the said computer program is executed by the said processor.

13. A computing device, comprising a memory, a processor, and a computer program stored in the said memory and executed in the said processor, characterized in that the steps as claimed in claim 4 are effectuated when the said computer program is executed by the said processor.

14. A computer-readable storage medium in which the computer program is stored, characterized in that the steps as claimed in claim 2 are effectuated when the said computer program is executed by the said processor.

15. A computer-readable storage medium in which the computer program is stored, characterized in that the steps as claimed in claim 3 are effectuated when the said computer program is executed by the said processor.

16. A computer-readable storage medium in which the computer program is stored, characterized in that the steps as claimed in claim 4 are effectuated when the said computer program is executed by the said processor.
